(19) United States
(12) Patent Application Publication
(10) Pub. No.: US 2025/0292766 A1
(43) Pub. Date: Sep. 18, 2025

(54) WAKE-UP MODEL WITH AUTO ENROLLMENT AND ON-DEVICE TRAINING

(71) Applicant: SAMSUNG ELECTRONICS CO., LTD., Suwon-si (KR)

(72) Inventors: Haoran WEI, San Jose, CA (US); Gowtham Srinivasan, San Jose, CA (US); Srinivasa Rao Ponakala, Sunnyvale, CA (US); Vijendra Raj Apsingekar, San Jose, CA (US)

(73) Assignee: SAMSUNG ELECTRONICS CO., LTD., Suwon-si (KR)

(21) Appl. No.: 19/071,401

(22) Filed: Mar. 5, 2025

Related U.S. Application Data
(60) Provisional application No. 63/565,327, filed on Mar. 14, 2024.

(51) Int. Cl. G10L 15/06; G10L 15/08

(52) U.S. Cl. CPC G10L 15/063; G10L 15/08; G10L 2015/088

(57) ABSTRACT

Methods, systems, and apparatuses for training a user-specific wake-up model, the method being performed by an electronic device and including: detecting, using a wake-up model, a wake-up command included in a voice input received from a user; based on the detecting of the wake-up command, performing a speech recognition operation based on the voice input; determining a confidence score based on a result of the speech recognition operation; based on the confidence score being above a threshold value, obtaining user-specific training data based on the voice input and a result of the speech recognition operation; and performing user-specific training on the wake-up model based on the user-specific training data to obtain a user-specific wake-up model that is trained to respond to the user.

### CROSS-REFERENCE TO RELATED APPLICATION(S)

This application is based on and claims priority under 35 U.S.C. § 119 to U.S. Provisional Patent Application No. 63/565,327, filed on Mar. 14, 2024, in the U.S. Patent & Trademark Office, the disclosure of which is incorporated by reference herein in its entirety.

### BACKGROUND

### 1. Field

The disclosure relates to speech recognition, and more particularly to performing user-specific training on a wake-up model for detecting a wake-up command.

### 2. Description of Related Art

Wake-up commands may refer to a word or phrase which may be used to activate a device when spoken by a user. A wake-up command may also be referred to as a hotword, trigger word, or wake-up word. For example, some electronic devices may include voice assistants or smart assistants which may be invoked using wake-up commands such as wake-up words. Examples of such wake-up words may include, but are not limited to, words or phrases such as “Hey Bixby”, “Hey Siri”, “OK Google”, and “Alexa”. This invocation of the voice assistant using a wake-up word may assist in protecting user privacy by recording voice inputs or establishing a connection to a cloud-based assistant only if the wake-up word is uttered by user.

A wake-up model may refer to a speech recognition model which may be specially trained to detect wake-up commands such as wake-up words. Many wake-up models may be trained based on a general training dataset including clean and augmented audio samples which include wake-up words. For example, the audio augmentations may include the addition of reverberation and noise augmentations, etc. After training, the thresholds and hyperparameters of the wake-up model may be calculated based on receiver operating characteristics (ROC) by running the model on a known set of samples including wake-up words. The deployed wake-up model may make wake-up decisions based on a fixed threshold.

However, users who speak different languages, or users with strong accents, may be unable to pronounce the wake-up word correctly. Accordingly, a wake-up model trained on a general training dataset may experience reduced performance when processing voice input from such users. In addition, users may provide voice inputs in various environments with different noise types. Accordingly, a general wake-up model may experience reduce performance according to one or more specific noise types.

Some approaches may involve performing an enrollment process to obtain user-specific training data which may be used to train the general wake-up model based on a specific voice characteristics or environments of the user. However, these enrollment processes may be cumbersome and inconvenient, for example by requiring the user to record a large number of audio samples including the wake-up command.

Therefore, there is a need for a wake-up model that has the ability to adapt to user accents and common environment noise types without a burdensome user-specific enrollment process.

### SUMMARY

Example embodiments address at least the above problems and/or disadvantages and other disadvantages not described above. Also, the example embodiments are not required to overcome the disadvantages described above, and may not overcome any of the problems described above.

In accordance with an aspect of the disclosure, a method of training a user-specific wake-up model, the method being performed by an electronic device and including: detecting, using a wake-up model, a wake-up command included in a voice input received from a user; based on the detecting of the wake-up command, performing a speech recognition operation based on the voice input; determining a confidence score based on a result of the speech recognition operation; based on the confidence score being above a threshold value, obtaining user-specific training data based on the voice input and a result of the speech recognition operation; and performing user-specific training on the wake-up model based on the user-specific training data to obtain a user-specific wake-up model that is trained to respond to the user.

The wake-up model may include a key word detector (KWD) model trained to detect a wake-up command, and a key word verifier (KWV) model trained to verify the wake-up command.

The performing of the user-specific training may include training the KWV model using the user-specific training data to obtain a user-specific KWV model.

The user-specific wake-up model may include the KWD model and the user-specific KWV model.

The determining of the confidence score may include: determining a wake-up score based on an output of the wake-up model; determining a speech recognition score based on the output of the speech recognition model; and determining the confidence score based on the wake-up score and the speech recognition score.

The method may further include collecting additional user-specific training data; obtaining a user-specific training dataset comprising the user-specific training data and the additional user-specific training data; and selecting a time to perform the user-specific training based on at least one parameter corresponding to the electronic device.

The at least one parameter may include at least one from among a computation power of the electronic device, battery usage information of the electronic device, an amount of the user-specific training data collected by the electronic device, and usage pattern information regarding usage patterns of the user.

The user-specific training may be performed by the electronic device.

The method may further include detecting, using the user-specific wake-up model, a new wake-up command included in a new voice input received from the user; based on the detecting of the new wake-up command, performing a new speech recognition operation based on the voice input; and based on a result of the new speech recognition operation indicating that a performance of the user-specific wake-up model is below a threshold performance, obtaining new user-specific training data based on the new voice input and the result of the new speech recognition operation, and performing additional user-specific training on the user-specific wake-up model based on the new user-specific training data.

In accordance with an aspect of the disclosure, an electronic device for training a user-specific wake-up model, the electronic device includes: at least one memory configured to store instructions; and at least one processor configured to execute the instructions to: detect, using a wake-up model, a wake-up command included in a voice input received from a user, based on detecting the wake-up command, perform a speech recognition operation based on the voice input, determine a confidence score based on a result of the speech recognition operation; based on the confidence score being above a threshold value, obtain user-specific training data based on the voice input and a result of the speech recognition operation, and perform user-specific training on the wake-up model based on the user-specific training data to obtain a user-specific wake-up model that is trained to respond to the user.

The wake-up model may include a key word detector (KWD) model trained to detect a wake-up command, and a key word verifier (KWV) model trained to verify the wake-up command.

To perform the user-specific training, the at least one processor may be further configured to execute the instructions to:
train the KWV model using the user-specific training data to obtain a user-specific KWV model.

The user-specific wake-up model may include the KWD model and the user-specific KWV model.

The at least one processor may be further configured to execute the instructions to: determine a wake-up score based on an output of the wake-up model; determine a speech recognition score based on the output of the speech recognition model; and determine the confidence score based on the wake-up score and the speech recognition score.

The at least one processor may be further configured to execute the instructions to: select a time to perform the user-specific training based on at least one parameter corresponding to the electronic device.

The at least one parameter may include at least one from among a computation power of the electronic device, battery usage information of the electronic device, an amount of the user-specific training data collected by the electronic device, and usage pattern information regarding usage patterns of the user.

The at least one processor may be further configured to execute the instructions to: detect, using the user-specific wake-up model, a new wake-up command included in a new voice input received from the user; based on the detecting of the new wake-up command, perform a new speech recognition operation based on the voice input; and based on a result of the new speech recognition operation indicating that a performance of the user-specific wake-up model is below a threshold performance, obtain new user-specific training data based on the new voice input and the result of the new speech recognition operation, and perform additional user-specific training on the user-specific wake-up model based on the new user-specific training data.

In accordance with an aspect of the disclosure, a non-transitory computer-readable medium stores instructions which, when executed by at least one processor of a device for training a user-specific wake-up model, cause the device to: detect, using a wake-up model, a wake-up command included in a voice input received from a user; based on the detecting of the wake-up command, perform a speech recognition operation based on the voice input; determine a confidence score based on a result of the speech recognition operation; based on the confidence score being above a threshold value, obtain user-specific training data based on the voice input and a result of the speech recognition operation; and perform user-specific training on the wake-up model based on the user-specific training data to obtain a user-specific wake-up model that is trained to respond to the user.

The wake-up model may include a key word detector (KWD) model trained to detect a wake-up command, and a key word verifier (KWV) model trained to verify the wake-up command, and to perform the user-specific training, the instructions may further cause the device to train the KWV model using the user-specific training data to obtain a user-specific KWV model, and the user-specific wake-up model may include the KWD model and the user-specific KWV model.

The instructions may further cause the device to: detect, using the user-specific wake-up model, a new wake-up command included in a new voice input received from the user; based on the detecting of the new wake-up command, perform a new speech recognition operation based on the voice input; and based on a result of the new speech recognition operation indicating that a performance of the user-specific wake-up model is below a threshold performance, obtain new user-specific training data based on the new voice input and the result of the new speech recognition operation, and perform additional user-specific training on the user-specific wake-up model based on the new user-specific training data.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram showing a general overview of an electronic device including a wake-up model, according to embodiments;

FIG. 2 is a diagram showing a wake-up model including a key word detector (KWD) model and a key word verifier (KWV) model, according to embodiments;

FIG. 3 is a diagram showing a management module, according to embodiments;

FIG. 4 is a flowchart illustrating a training pipeline for a wake-up model, according to embodiments;

FIGS. 5A to 5C are flowcharts illustrating processes for training a user-specific wake-up model, according to embodiments;

FIG. 6 is a block diagram of an electronic device according to embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

The term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As discussed above, a wake-up model may refer to a speech recognition model which may be specially trained to detect wake-up commands such as wake-up words, which may be used to trigger additional processing of voice inputs, for example by voice assistants or smart assistants.

In general, wake-up models and similar speech recognition technologies may have a wide array of applications across various industries and aspects of daily life in various environments. For example, beyond simple voice commands to play music or set alarms, wake-up models may be used in smart home automation to control lighting, temperature, security systems, and even kitchen appliances, making homes more interconnected and responsive. In medical or healthcare settings, wake-up models may help with patient care by allowing hands-free operation of equipment or access to patient records, thus maintaining sterility and improving efficiency. In vehicles, wake-up models may enhance driver safety by enabling hands-free control of car functions, navigation, and entertainment systems, minimizing distractions. In addition, wake-up models may assist in creating more interactive learning environments and making technology more accessible to individuals with physical disabilities by enabling voice commands for computer and mobile device control. In devices such as smartwatches and fitness trackers, wake-up models and voice commands may facilitate ease of use, especially during activities like running or cycling where hands-free operation is essential. In retail and e-commerce, wake-up models may be used in voice-activated systems which may offer customers a more interactive shopping experience, both in physical stores and online platforms, by helping with product searches, information, and purchases. In gaming and virtual reality (VR) and augmented reality (AR) devices, wake-up models may add an extra layer of immersion to gaming and VR/AR experiences by allowing users to interact with the game/virtual/real environment or control an head-mounted device (HMD) through voice commands. In industrial automation, manufacturing and warehousing, wake-up models and voice commands may streamline operations, allowing workers to operate machinery or access inventory hands-free, increasing safety and efficiency.

Wake-up models, which may be part of the broader category of speech recognition and interaction technologies, also have significant potential for use in robotics and various other applications. In robotics, particularly, such models can enhance the way robots understand and respond to human commands, making interactions more intuitive and efficient. Moreover, advancements in AI are pushing the boundaries of how robots can be integrated into various sectors, including healthcare, education, and smart city initiatives. Robots equipped with AI can perform tasks ranging from caregiving to waste management more efficiently. Furthermore, the integration of generative AI, such as the technology behind large language models such as ChatGPT, into robotics suggests a future where robots could understand and respond to human language in more nuanced ways, enhancing their utility and accessibility. AI and robotics are also making significant strides in practical applications in various industries in noisy environments. Given these developments, wake-up models and related AI technologies have broad applicability, extending from robotics to various industrial fields.

Accordingly, embodiments may allow for increased utility of wake-up models in the above and other areas by providing an improved process for training a user-specific wake-up model, which may have improved performance for a particular user and/or a particular use environment. A general wake-up model, which may be trained based on a general training dataset including clean and augmented audio samples which include wake-up words, may be effective for many users. However, users who speak different languages, or users with strong accents, may be unable to pronounce the wake-up word correctly. Accordingly, a general wake-up model trained on a general training dataset may experience reduced performance when processing voice input from such users. In addition, users may provide voice inputs in various environments with different noise types, which may also cause reduced performance when using a general wake-up model.

User-specific training may be used to train a general wake-up model to have increased performance for a particular user. The user-specific training may be performed based on user-specific training data, which may be collected using an enrollment process. However, many approaches to these enrollment processes may be cumbersome and inconvenient, for example by requiring the user to repeatedly record a large number of audio samples including the wake-up command.

Accordingly, embodiments may relate to an on-device training process which may be used to obtain a user-specific wake-up model that provides improved performance for users with unusual voice characteristics such as strong accents, or for voice inputs which are received in unusual environments. In some embodiments, the timing or manner of the on-device training may be selected in consideration of computational power and energy capabilities of various devices.

Embodiments may perform the on-device training without requiring a user to undergo a cumbersome enrollment process. For example, embodiments may relate to an auto-enrollment process which may include selecting valid wake-up commands to be included in a user-specific training dataset by calculating confidence scores corresponding to voice inputs received from a user. In some embodiments, a general wake-up model, which may have a basic capability to perform wake-up detection without user-specific training, may be used during the auto-enrollment process to collect the user-specific training data. Then, the user-specific wake-up model may be obtained by performing a user-specific training process on the general wake-up model based on the user-specific training data. In addition, embodiments may monitor and evaluate the performance of the user-specific wake-up model, and may provide the ability to update the user-specific training data by performing the auto-enrollment process again, so that the user-specific wake-up model may maintain high performance even when confronted with changes in user voice characteristics or environments.

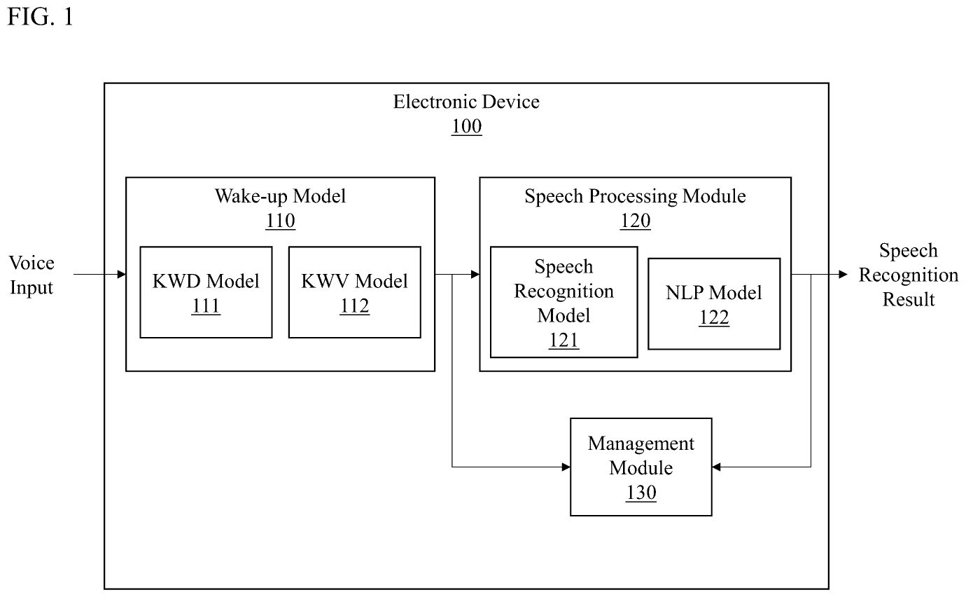

FIG. 1 is a diagram showing a general overview of an electronic device including a wake-up model, according to embodiments.

As shown in FIG. 1, an electronic device 100 may include a wake-up model 110, a speech processing module 120, and a management module 130. In embodiments, at least one of the wake-up model 110 and the speech processing module 120 may be used to implement a voice assistant or smart assistant which may interact with a user of the electronic device 100, but embodiments are not limited thereto.

As shown in FIG. 1, the wake-up model 110 may include a two-pass architecture including a key word detector (KWD) model 111 and a key word verifier (KWV) model 112. According to embodiments, the wake-up model 110 may monitor voice inputs received by the electronic device 100, for example using a physical input interface such as a microphone, to detect a wake-up command such as a wake-up word. If the wake-up model 110 determines that a voice input includes a valid wake-up command such as a wake-up word, the voice input may be provided to the speech processing module 120 for further processing.

As shown in FIG. 1, the speech processing module 120 may include at least one of a speech recognition model 121 and a natural language processing (NLP) model 122, but embodiments are not limited thereto. In embodiments, one or more of the speech processing module 120, the speech recognition model 121, and the NLP model 122 may be used to generate and provide outputs to the user based on the received voice inputs which include a wake-up command. For example, one or more of the speech processing module 120, the speech recognition model 121, and the NLP model 122 may be included in, or used to implement, a voice assistant or smart assistant which may be triggered by the wake-up command, and which may generate and output responses to user commands or user queries included in the voice input. In some embodiments, the responses may include at least one of operations which may be performed by the electronic device 100 in response to user commands, and voice responses or text responses which may be output by the electronic device in response to user queries, but embodiments are not limited thereto.

The management module 130 may be used to control operations of at least one of the wake-up model 110 and the speech processing module 120. For example, the management module 130 may be used to perform training on at least one of the wake-up model 110 and the speech processing module 120.

According to embodiments, the wake-up model 110 may begin as a general wake-up model 110, which may be trained based on a general training dataset including audio samples collected from a variety of users. While the electronic device 100 is operating, a user may interact with a voice assistant or smart assistant included in or implemented by the electronic device 100. According to embodiments, voice inputs which successfully trigger an extended interaction with the voice assistant, for example a conversation between the user and the voice assistant, may be assigned a high confidence score by the management module 130. Voice inputs which have high confidence scores, for example confidence scores which are above a predetermined threshold, may be collected and saved during an auto-enrollment process performed by the management module 130 or another component of the electronic device 100, and may be used to perform user-specific training, for example a user-specific training process, on the general wake-up model 110 to obtain a user-specific wake-up model 110, which may have improved performance when processing voice inputs received from a particular user. For example, in some embodiments, the user-specific wake-up model 110 may be better able to identify or detect wake-up commands included in voice inputs received from the user, in comparison with a general wake-up model 110, on which the user-specific training process has not been performed.

The auto-enrollment process and the user-specific training process may be repeated periodically, depending on parameters such as an amount of user-specific training data that is collected by the electronic device 100, a computation power of the electronic device 100, and battery usage of the electronic device 100, but embodiments are not limited thereto. For example, in some embodiments, the auto-enrollment process and the user-specific training process may be repeated every few days, but embodiments are not limited thereto.

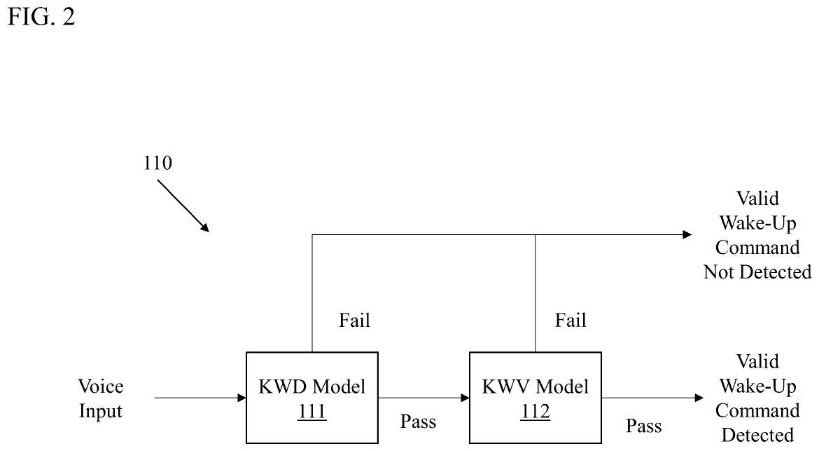

FIG. 2 is a diagram showing a wake-up model including a key word detector (KWD) model and a key word verifier (KWV) model, according to embodiments.

According to embodiments, the KWD model 111 may perform KWD checks by continuously listening for voice inputs which include a potential wake-up command such as a wake-up word. For example, in some embodiments, the KWD model 111 may be a frame-level detector, but embodiments are not limited thereto. The KWV model 112 may be triggered after a particular voice input passes a KWD check, and may be used to perform a KWV check to determine whether the potential wake-up command is a valid wake-up command. A valid wake-up command may refer to a potential wake-up command that passes both the KWD check by the KWD model 111 and the KWV check by the KWV model 112. If the potential wake-up command fails either the KWD check by the KWD model 111 or the KWV check by the KWV model 112, the wake-up model 110 may determine that the potential wake-up command is not a valid wake-up command. As discussed above, based on a valid wake-up command being detected by the wake-up model 110, other functions or operations of the electronic device 100 may be triggered. For example, based on a valid wake-up command being detected by the wake-up model 110, the corresponding voice input may be provided to the speech processing module 120 for further processing.

For example, in some embodiments, the input of the wake-up model 110 may be feature information converted or extracted from a voice input or training data, and the output of the wake-up model 110 may be a yes/no decision or pass/fail decision about whether the voice input should be recorded and provided to another component such as the speech processing module 120, but embodiments are not limited thereto.

In some embodiments, the KWD model 111 may operate using a relatively small amount of resources (e.g., around 20 kilobytes of storage space) and the KWV model 112 may operate using a comparatively large amount of resources (e.g., around 5 megabytes of storage space), but embodiments are not limited thereto. According to embodiments, the KWD model 111 and the KWV model 112 may operate using different elements or components included in the electronic device 100. For example, in some embodiments, KWD model 111 may operate using an element which is frequently run, for example a digital signal processor (DSP), and KWV model 112 may operate using a different element such as a different processor, but embodiments are not limited thereto.

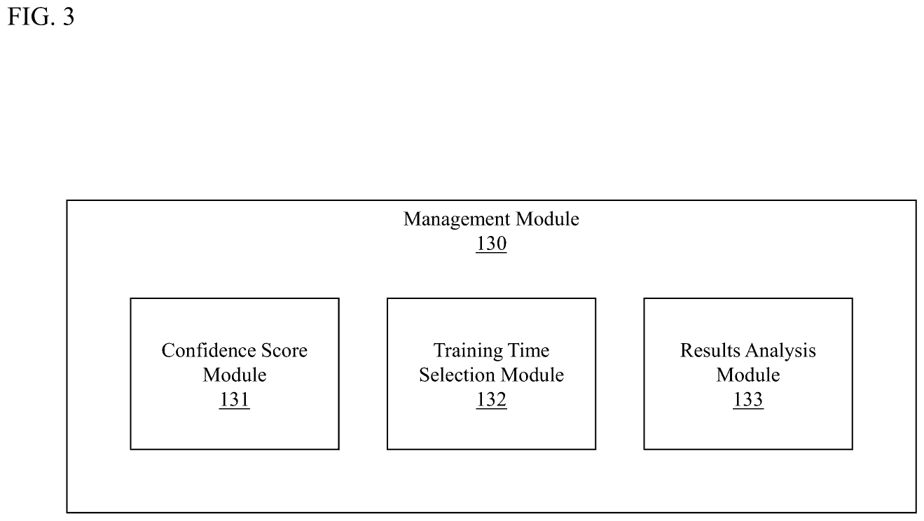

FIG. 3 is a diagram showing a management module, according to embodiments. As shown in FIG. 3, the management module 130 may include a confidence score module 131, a training time selection module 132, and a results analysis module 133.

In embodiments, the confidence score module 131 may be used to determine a confidence score associated with a voice input, in order to determine whether user-specific training data corresponding to the voice input should be stored, for example by being included in a user-specific training dataset stored on the electronic device 100 to be used for user-specific training of the wake-up model 110. This evaluation of voice inputs may be included in an auto-enrollment process, in which user-specific training data is collected during regular interactions between the user and the electronic device 100, for example when the user is using a voice assistant or smart assistant implemented by the electronic device 100. Based on the auto-enrollment process, the user may not be required to record audio samples in a separate enrollment process before using the voice assistant, because audio samples for training the user-specific wake-up model 110 may be selected based on the confidence score. For each voice input that successfully passes through the wake-up model 110 and the speech processing module 120, the confidence score module 131 may determine the corresponding confidence score by combining an output score determined by the KWV model 112 and an output score determined by one or more of the speech processing module 120, the speech recognition model 121, and the NLP model 122. When the confidence score is greater than a threshold, the voice input or information about the voice input may be added to a user-specific training dataset which may be used to train the user-specific wake-up model 110.

In embodiments, the training time selection module 132 may be used to determine an appropriate time for performing the user-specific training process used to obtain the user-specific wake-up model 110. According to embodiments, the training time selection module 132 may obtain information about at least one of the electronic device 100 and the user, and may use this information to select an appropriate time to perform the user-specific training process. For example, in embodiments the training time selection module 132 may consider factors or parameters such as an amount of user-specific data which has been collected by the electronic device 100, a computation power of the electronic device 100, a battery usage history of the electronic device 100, a current battery charge status of the electronic device 100, and usage pattern information regarding usage patterns of the user. For example, after determining that a predetermined amount of user-specific training data has been collected, the training time selection module 132 may select a time at which the user is not expected to use the electronic device 100, and at which the battery of the electronic device 100 is expected to be charged to an acceptable level, and the electronic device 100 may perform the user-specific training process at the selected time. Accordingly, the user-specific wake-up model 110 may be trained to be adaptive to personal information of the user, such as an accent of the user and daily environment noise encountered by the user, and the user-specific training process may be performed without interrupting normal use of the electronic device 100 by the user, and without draining the battery of the electronic device to an unnecessarily low level. However, embodiments are not limited thereto, and the training time selection module 132 may select a training time based on any parameters or factors.

In embodiments, the results analysis module 133 may be used to monitor performance of the user-specific wake-up model 110 and determine whether to collect new auto-enrollment data and retrain the user-specific wake-up model 110. For example, the results analysis module 133 may determine a number of voice inputs which the user-specific wake-up model 110 incorrectly identified as including a wake-up command, and may determine the performance of the user-specific wake-up model 110 based on this number. Accordingly, if the user changes their daily environment and the user-specific wake-up model 110 no longer performs well, the results analysis module 133 may determine to trigger the auto-enrollment process and the user-specific training process again.

Although examples are described herein in which the confidence score module 131, the training time selection module 132, and the results analysis module 133 are included in a management module 130, which is included in the electronic device 100, embodiments are not limited thereto. For example, in some embodiments, one or more of the confidence score module 131, the training time selection module 132, and the results analysis module 133 may be included in the electronic device 100 but not included in the management module 130. In addition, in some embodiments, the functions described with reference to the confidence score module 131, the training time selection module 132, and the results analysis module 133 may be performed by a single element or component, for example by the management module 130, or by some other element or component which may be included in the electronic device 100, or included in another device which communicates with the electronic device 100.

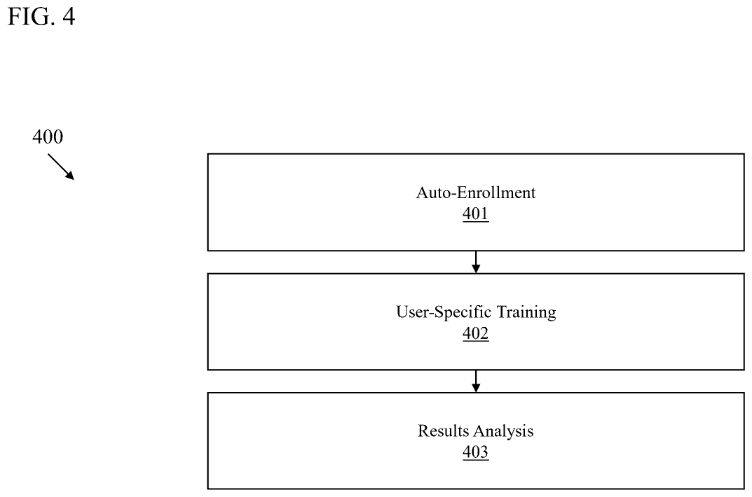

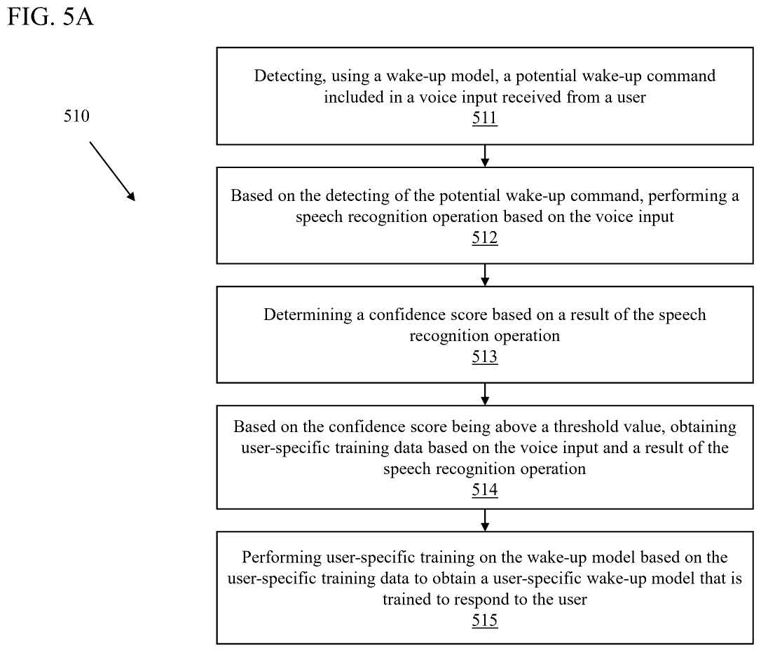

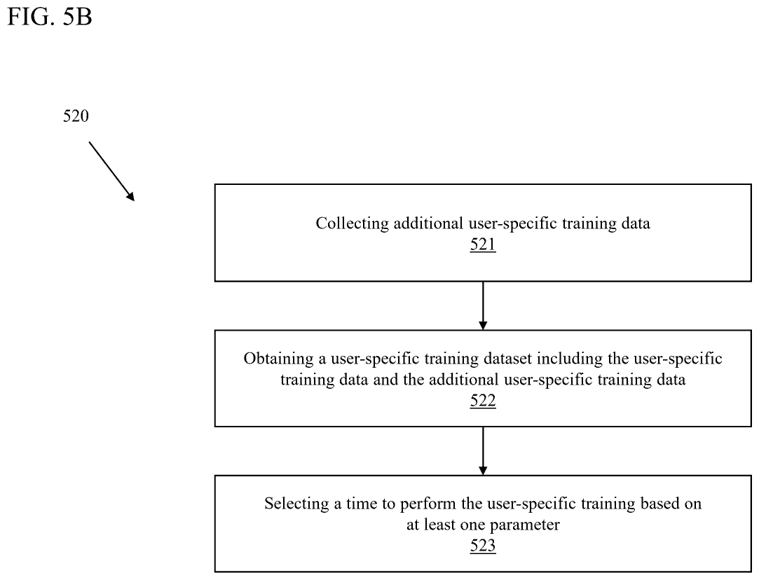

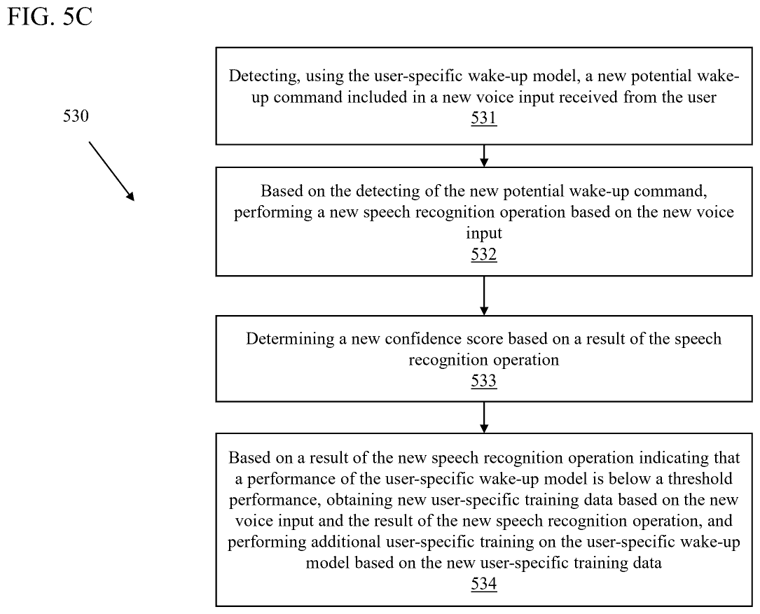

Examples of operations of the electronic device 100 and the elements included therein are provided below with reference to FIGS. 4 and 5A-5C.

FIG. 4 is a flowchart illustrating a training pipeline for a wake-up model, according to embodiments. According to embodiments, the training pipeline 400 may include auto-enrollment 401, user-specific training 402, and results analysis 403.

According to embodiments, auto-enrollment 401 may include building a user-specific training dataset by finding and storing voice inputs which include wake-up commands. In some embodiments, during auto-enrollment 401, or the first time that auto-enrollment 401 is performed, a general wake-up model 110 may be used along with the speech processing module 120. For example, the confidence score module 131 may determine confidence scores for voice inputs based on an output of the wake-up model 110 and the speech processing module 120, and may store voice inputs having relatively high confidence scores as user-specific training data. In some embodiments, if the speech processing module 120 is used to implement a voice assistant, the confidence score module 131 may determine a voice input to have a high confidence score based on the voice input resulting in an extended conversation between the user and the voice assistant, and may determine a voice input to have a low confidence score based on the user not interacting with the voice assistant after the voice input received, but embodiments are not limited thereto. Because a general wake-up model 110 may be used, auto-enrollment 401 may be performed while the user makes normal or regular use of the device, and therefore may allow the electronic device 100 to obtain a user-specific training dataset without requiring the user to undergo a separate enrollment process.

According to embodiments, user-specific training 402 may be used to train the general wake-up model 110 to obtain a user-specific wake-up model 110, which may have improved performance for a particular user, based on the user-specific training dataset collected during auto-enrollment 401. In embodiments, user-specific training 402 may be performed on or by the electronic device 100, and may be referred to as on-device training. With increasing computation power on electronic devices such as mobile devices, with the emergence of hardware such as mobile AI chips, training deep learning models may be performed on mobile devices such as the electronic device 100, to perform the on-device training. On-device training may be used to leverage decentralized computational resources and save training costs on cloud servers. On-device training may also help to solve user privacy and security issues, by utilizing user data only on local devices. As discussed above, the training time selection module 132 may select a training time and training period based on various parameters, for example a battery usage history of the electronic device 100 and a current battery charge status of the electronic device 100. In some embodiments, the user-specific training 402 may be paused to accommodate the user, for example when user starts to use the electronic device 100, so that the user-specific training 402 may be performed without interfering with the regular or normal use of the electronic device 100.

As discussed above, the user-specific wake-up model 110 may be obtained by training the general wake-up model 110. In some embodiments, the general wake-up model 110 may include a KWD model 111 and a general KWV model 112, and the user-specific training may include training the KWV model 112 to obtain a user-specific KWV model 112. Accordingly, the user-specific wake-up model 110 may include the same KWD model 111 as the general wake-up model 110, and may further include the user-specific KWV model 112, but embodiments are not limited thereto. In some embodiments, the architecture of the user-specific wake-up model 110 may be the same as or similar to the architecture of the general wake-up model 110, and the user-specific training 402 may include modifying parameters of the general wake-up model 110, for example weights and/or thresholds in one or more layers of the general wake-up model 110 and/or the general KWV model 112, in order to obtain the user-specific wake-up model 110. After the user-specific training 402, the electronic device 100 may use the user-specific wake-up model 110 instead of the general wake-up model 110.

According to embodiments, results analysis 403 may include monitoring a performance of the user-specific wake-up model 110 in order to determine whether to repeat the user-specific training 402 based on updated user-specific training data. In some embodiments, the auto-enrollment 401 may be continuously performed while the results analysis 403 is performed, or may be performed after a result of the results analysis 403 indicates that the user-specific training 402 should be repeated (e.g., indicates that a new user-specific training 402 should be performed). For example, based on a change in at least one of voice characteristic of the user and an environment of the user, a performance of the user-specific wake-up model 110 may be degraded, for example by dropping below a threshold. In some embodiments, the performance of the user-specific wake-up model 110 may be determined by analyzing a confidence score distribution of confidence scores for voice inputs, but embodiments are not limited thereto.

Accordingly, the results analysis module 133 may determine to repeat one or more of the auto-enrollment 401 and the user-specific training 402 to update the user-specific wake-up model 110 based on newly-collected user-specific training data. A time for performing the new user-specific training 402 may be selected by the training time selection module 132 based on the determination made by the results analysis module 133. After the new user-specific training 402, the electronic device 100 may use the new or updated user-specific wake-up model 110 instead of the previous user-specific wake-up model 110. In addition, after the new user-specific training 402, the pipeline 400 may include performing a new results analysis 403.

FIG. 5A is a flowchart of a process for training a wake-up model, according to embodiments. In embodiments, the process 510 illustrated in FIG. 5A may be performed by any of the elements discussed above, for example at least one of the electronic device 100 and any of the components or elements included therein.

At operation 511, the process 510 may include detecting, using a wake-up model, a potential wake-up command included in a voice input received from a user. In embodiments, the wake-up model may correspond to the general wake-up model 110 discussed above. In embodiments, the wake-up model may include a KWD model trained to detect a wake-up command, and a KWV model trained to verify the wake-up command. In embodiments, the KWD model may correspond to the KWD model 111 discussed above, and the KWV model may correspond to the KWV model 112 discussed above.

At operation 512, the process 510 may include, based on the detecting of the potential wake-up command, performing a speech recognition operation based on the voice input. In embodiments, the speech recognition operation may be performed by the speech processing module 120 discussed above.

At operation 513, the process 510 may include determining a confidence score based on a result of the speech recognition operation. In embodiments, the confidence score may be determined by the confidence score module 131 discussed above. In embodiments, the determining of the confidence score may include determining a wake-up score based on an output of the wake-up model; determining a speech recognition score based on the output of the speech recognition model; and determining the confidence score based on the wake-up score and the speech recognition score.

At operation 514, the process 510 may include, based on the confidence score being above a threshold value, obtaining user-specific training data based on the voice input and a result of the speech recognition operation. In embodiments, operations 513 and 514 may correspond to the auto-enrollment 401 discussed above.

At operation 515, the process 510 may include performing user-specific training on the wake-up model based on the user-specific training data to obtain a user-specific wake-up model that is trained to respond to the user. In embodiments, operation 515 may correspond to the user-specific training 402 discussed above. In embodiments, the performing of the user-specific training may include training the KWV model using the user-specific training data to obtain a user-specific KWV model. In embodiments, the user-specific wake-up model may include the KWD model and the user-specific KWV model. In embodiments, the user-specific training may be performed by the electronic device.

FIG. 5B is a flowchart of a process for training a wake-up model, according to embodiments. In embodiments, the process 520 illustrated in FIG. 5B may be performed by any of the elements discussed above, for example at least one of the electronic device 100 and any of the components or elements included therein.

At operation 521, the process 520 may include collecting additional user-specific training data, and at operation 522, the process 520 may include obtaining a user-specific training dataset including the user-specific training data and the additional user-specific training data.

At operation 523, the process 520 may include selecting a time to perform the user-specific training based on at least one parameter. In embodiments, operation 523 may be performed by the training time selection module 132 discussed above. In embodiments, the at least one parameter may include at least one from among a computation power of the electronic device, battery usage information of the electronic device, an amount of the user-specific training data collected by the electronic device, and usage pattern information regarding usage patterns of the user.

FIG. 5C is a flowchart of a process for training a wake-up model, according to embodiments. In embodiments, the process 530 illustrated in FIG. 5C may be performed by any of the elements discussed above, for example at least one of the electronic device 100 and any of the components or elements included therein.

At operation 531, the process 530 may include detecting, using the user-specific wake-up model, a new potential wake-up command included in a new voice input received from the user.

At operation 532, the process 530 may include, based on the detecting of the new potential wake-up command, performing a new speech recognition operation based on the new voice input.

At operation 533, the process 530 may include determining a new confidence score based on a result of the speech recognition operation.

At operation 534, the process 530 may include, based on a result of the new speech recognition operation indicating that a performance of the user-specific wake-up model is below a threshold performance, obtaining new user-specific training data based on the new voice input and the result of the new speech recognition operation, and performing additional user-specific training on the user-specific wake-up model based on the new user-specific training data. In embodiments, operation 534 may correspond to the results analysis 403 discussed above, and may be performed by the results analysis module 133.

Accordingly, embodiments may relate to a method of recognizing a wake-up word for voice assistant. Embodiments may relate to automatically identifying audio samples that can be used as training data to personalize a wake-up model for a specific user without requiring the user to go through an separate enrollment step. The audio samples may be identified by selecting training data among audio samples that a general wake-up model determines to include a wake-up command such as a wake-up word, passing the audio samples through at least one of a speech recognition model and a natural language processing model trained to predict what the user is saying in the audio samples; determining the audio samples that lead to a further conversation between the voice assistant and the user to have high confidence scores; and selecting the audio samples having high confidence scores as training data. Embodiments may relate to updating parameters in one or more layers of the general wake-up model using the training data to become a user-specific wake-up model based in part on information about device computation power, battery usage, battery level, time, and device capabilities. Embodiments may relate to, after deploying the specific wake-up model, tracking confidence score distribution of the user's new audio samples that successfully lead to conversations with the voice assistant, and when the confidence score distribution is below a satisfactory threshold, repeating the auto-enrollment to collect new training data and re-training the wake-up model.

Accordingly, embodiments may provide an auto-enrollment process which may allow for training of a user-specific wake-up model without a separate enrollment process that requires the user to record additional repetitive voice inputs before using a voice assistant.

In addition, embodiments may provide an on-device user-specific training process which may allow for the training of a user-specific wake-up model that is adaptive to voice characteristics and environments of the user, which may allow the user-specific wake-up model to have increased accuracy with respect to the user, and also decrease false triggers by other people, while decreasing a privacy risk of the user by reducing the need to share user-specific training data with other devices. In addition, embodiments may provide a results analysis process which may allow the user-specific wake-up model to be retrained based on changes in the user voice characteristics or environment.

In addition, embodiments may be adapted for named entity recognition (NER). For example, training data may be selected from among audio samples that the speech processing module 120 determines to include names of entities such as people. Other applications such as speaker verification can use similar approaches to automatically collect enrollment audio from the user. For text to speech (TTS) related applications, the user-specific training data collected during the auto-enrollment process may be used for voice cloning.

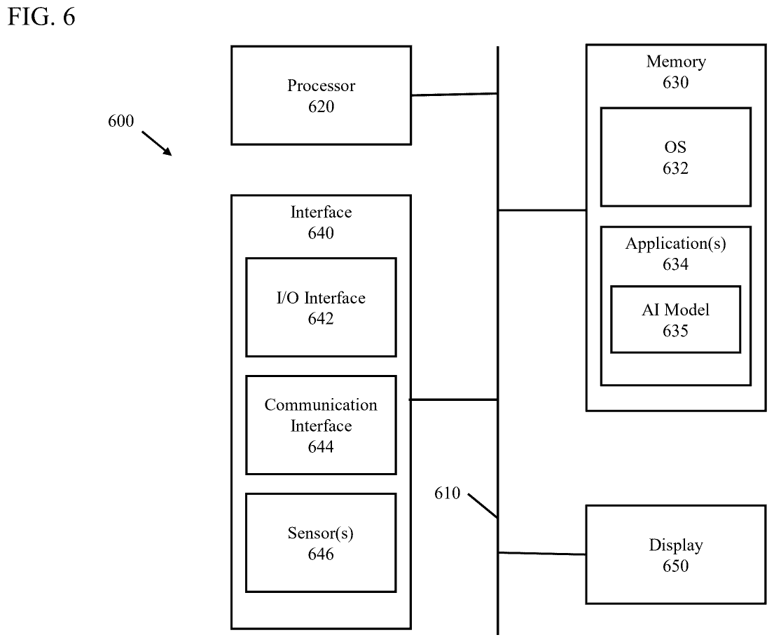

FIG. 6 is a block diagram of an electronic device according to embodiments

FIG. 6 is for illustration only, and other embodiments of the electronic device 600 could be used without departing from the scope of this disclosure. For example, the electronic device 600 may correspond to at least one of the electronic device 100 and any of the elements or components included therein.

The electronic device 600 includes a bus 610, a processor 620, a memory 630, an interface 640, and a display 650.

The bus 610 includes a circuit for connecting the components 620 to 650 with one another. The bus 610 functions as a communication system for transferring data between the components 620 to 650 or between electronic devices.

The processor 620 includes one or more of a central processing unit (CPU), a graphics processor unit (GPU), an accelerated processing unit (APU), a many integrated core (MIC), a field-programmable gate array (FPGA), or a digital signal processor (DSP). The processor 620 is able to perform control of any one or any combination of the other components of the electronic device 600, and/or perform an operation or data processing relating to communication. For example, the processor 620 may perform operations of the pipeline 400 illustrated in FIG. 4 and the processes 510, 520, and 530 illustrated in FIGS. 5A-5C. The processor 620 executes one or more programs stored in the memory 630.

The memory 630 may include a volatile and/or non-volatile memory. The memory 630 stores information, such as one or more of commands, data, programs (one or more instructions), applications 634, etc., which are related to at least one other component of the electronic device 600 and for driving and controlling the electronic device 600. For example, commands and/or data may formulate an operating system (OS) 632. Information stored in the memory 630 may be executed by the processor 620.

The applications 634 include the above-discussed embodiments. These functions can be performed by a single application or by multiple applications that each carry out one or more of these functions. For example, the applications 634 may include artificial intelligence (AI) models for performing operations of the pipeline 400 illustrated in FIG. 4 and the processes 510, 520, and 530 illustrated in FIGS. 5A-5C. Specifically, the applications 634 may include at least one of a wake-up model 110, a KWD model 111, a KWV model 112, a speech recognition model 121, an NLP model 122, and any of the elements included in the management module 130, according to embodiments of the disclosure.

The display 650 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display.

The interface 640 includes input/output (I/O) interface 642, communication interface 644, and/or one or more sensors 646. The I/O interface 642 serves as an interface that can, for example, transfer commands and/or data between a user and/or other external devices and other component(s) of the electronic device 600.

The communication interface 644 may include a transceiver to enable communication between the electronic device 600 and other external devices (e.g., a sensor node or a fusion center), via a wired connection, a wireless connection, or a combination of wired and wireless connections. The communication interface 644 may permit the electronic device 600 to receive information from another device and/or provide information to another device. For example, the communication interface 644 may include an Ethernet interface, an optical interface, a coaxial interface, an infrared interface, a radio frequency (RF) interface, a universal serial bus (USB) interface, a Wi-Fi interface, a cellular network interface, or the like.

The transceiver of the communication interface 644 may include a radio frequency (RF) circuitry and a baseband circuitry.

The baseband circuitry may transmit and receive a signal through a wireless channel, and may perform band conversion and amplification on the signal. The RF circuitry may up-convert a baseband signal provided from the baseband circuitry into an RF band signal and then transmits the converted signal through an antenna, and down-converts an RF band signal received through the antenna into a baseband signal. For example, the RF circuitry may include a transmission filter, a reception filter, an amplifier, a mixer, an oscillator, a digital-to-analog converter (DAC), and an analog-to-digital converter (ADC).

The transceiver may be connected to one or more antennas. The RF circuitry of the transceiver may include a plurality of RF chains and may perform beamforming. For the beamforming, the RF circuitry may control a phase and a size of each of the signals transmitted and received through a plurality of antennas or antenna elements. The RF circuitry may perform a downlink multi-input and multi-output (MIMO) operation by transmitting one or more layers.

The baseband circuitry may perform conversion between a baseband signal and a bitstream according to a physical layer standard of the radio access technology. For example, when data is transmitted, the baseband circuitry generates complex symbols by encoding and modulating a transmission bitstream. When data is received, the baseband circuitry reconstructs a reception bitstream by demodulating and decoding a baseband signal provided from the RF circuitry.

The sensor(s) 646 of the interface 640 can meter a physical quantity or detect an activation state of the electronic device 600 and convert metered or detected information into an electrical signal. For example, the sensor(s) 646 can include one or more cameras or other imaging sensors for capturing images of scenes. The sensor(s) 646 can also include any one or any combination of a microphone, a keyboard, a mouse, and one or more buttons for touch input. The sensor(s) 646 can further include an inertial measurement unit. In addition, the sensor(s) 646 can include a control circuit for controlling at least one of the sensors included herein. Any of these sensor(s) 646 can be located within or coupled to the electronic device 600.

The foregoing disclosure provides illustration and description, but is not intended to be exhaustive or to limit the implementation to the precise form disclosed. Modifications and variations are possible in light of the above disclosure or may be acquired from practice of the implementation.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 600, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The methods and processes described above may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of the electronic device 600.

A model related to the neural networks described above may be implemented via a software module. When the model is implemented via a software module (for example, a program module including instructions), the model may be stored in a computer-readable recording medium.

Also, the model may be a part of the electronic device 600 described above by being integrated in a form of a hardware chip. For example, the model may be manufactured in a form of a dedicated hardware chip for artificial intelligence, or may be manufactured as a part of an existing general-purpose processor (for example, a CPU or application processor) or a graphic-dedicated processor (for example a GPU).

Also, the model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

While the embodiments of the disclosure have been described with reference to the figures, it will be understood by those of ordinary skill in the art that various changes in form and details may be made therein without departing from the spirit and scope as defined by the following claims.

What is claimed is:

1. A method of training a user-specific wake-up model, the method being performed by an electronic device and comprising:
detecting, using a wake-up model, a wake-up command included in a voice input received from a user;
based on the detecting of the wake-up command, performing a speech recognition operation based on the voice input;
determining a confidence score based on a result of the speech recognition operation;
based on the confidence score being above a threshold value, obtaining user-specific training data based on the voice input and a result of the speech recognition operation; and
performing user-specific training on the wake-up model based on the user-specific training data to obtain a user-specific wake-up model that is trained to respond to the user.

2. The method of claim 1, wherein the wake-up model comprises a key word detector (KWD) model trained to detect a wake-up command, and a key word verifier (KWV) model trained to verify the wake-up command.

3. The method of claim 2, wherein the performing of the user-specific training comprises training the KWV model using the user-specific training data to obtain a user-specific KWV model.

4. The method of claim 3, wherein the user-specific wake-up model comprises the KWD model and the user-specific KWV model.

5. The method of claim 1, wherein the determining of the confidence score comprises:
determining a wake-up score based on an output of the wake-up model;
determining a speech recognition score based on the output of the speech recognition model; and
determining the confidence score based on the wake-up score and the speech recognition score.

6. The method of claim 1, further comprising:
collecting additional user-specific training data;
obtaining a user-specific training dataset comprising the user-specific training data and the additional user-specific training data; and
selecting a time to perform the user-specific training based on at least one parameter corresponding to the electronic device.

7. The method of claim 6, wherein the at least one parameter comprises at least one from among a computation power of the electronic device, battery usage information of the electronic device, an amount of the user-specific training data collected by the electronic device, and usage pattern information regarding usage patterns of the user.

8. The method of claim 1, wherein the user-specific training is performed by the electronic device.

9. The method of claim 1, further comprising:
detecting, using the user-specific wake-up model, a new wake-up command included in a new voice input received from the user;
based on the detecting of the new wake-up command, performing a new speech recognition operation based on the voice input; and
based on a result of the new speech recognition operation indicating that a performance of the user-specific wake-up model is below a threshold performance, obtaining new user-specific training data based on the new voice input and the result of the new speech recognition operation, and performing additional user-specific training on the user-specific wake-up model based on the new user-specific training data.

10. An electronic device for training a user-specific wake-up model, the electronic device comprising:
at least one memory configured to store instructions; and
at least one processor configured to execute the instructions to:
detect, using a wake-up model, a wake-up command included in a voice input received from a user,
based on detecting the wake-up command, perform a speech recognition operation based on the voice input,
determine a confidence score based on a result of the speech recognition operation;
based on the confidence score being above a threshold value, obtain user-specific training data based on the voice input and a result of the speech recognition operation, and
perform user-specific training on the wake-up model based on the user-specific training data to obtain a user-specific wake-up model that is trained to respond to the user.

11. The electronic device of claim 10, wherein the wake-up model comprises a key word detector (KWD) model trained to detect a wake-up command, and a key word verifier (KWV) model trained to verify the wake-up command.

12. The electronic device of claim 11, wherein to perform the user-specific training, the at least one processor is further configured to execute the instructions to:
train the KWV model using the user-specific training data to obtain a user-specific KWV model.

13. The electronic device of claim 12, wherein the user-specific wake-up model comprises the KWD model and the user-specific KWV model.

14. The electronic device of claim 10, wherein the at least one processor is further configured to execute the instructions to:
determine a wake-up score based on an output of the wake-up model;
determine a speech recognition score based on the output of the speech recognition model; and
determine the confidence score based on the wake-up score and the speech recognition score.

15. The electronic device of claim 10, wherein the at least one processor is further configured to execute the instructions to:
select a time to perform the user-specific training based on at least one parameter corresponding to the electronic device.

16. The electronic device of claim 15, wherein the at least one parameter comprises at least one from among a computation power of the electronic device, battery usage information of the electronic device, an amount of the user-specific training data collected by the electronic device, and usage pattern information regarding usage patterns of the user.

17. The electronic device of claim 10, wherein the at least one processor is further configured to execute the instructions to:
detect, using the user-specific wake-up model, a new wake-up command included in a new voice input received from the user;
based on the detecting of the new wake-up command, perform a new speech recognition operation based on the voice input; and
based on a result of the new speech recognition operation indicating that a performance of the user-specific wake-up model is below a threshold performance, obtain new user-specific training data based on the new voice input and the result of the new speech recognition operation, and perform additional user-specific training on the user-specific wake-up model based on the new user-specific training data.

18. A non-transitory computer-readable medium storing instructions which, when executed by at least one processor of a device for training a user-specific wake-up model, cause the device to:
detect, using a wake-up model, a wake-up command included in a voice input received from a user;
based on the detecting of the wake-up command, perform a speech recognition operation based on the voice input;
determine a confidence score based on a result of the speech recognition operation;
based on the confidence score being above a threshold value, obtain user-specific training data based on the voice input and a result of the speech recognition operation; and
perform user-specific training on the wake-up model based on the user-specific training data to obtain a user-specific wake-up model that is trained to respond to the user.

19. The non-transitory computer-readable medium of claim 18, wherein the wake-up model comprises a key word detector (KWD) model trained to detect a wake-up command, and a key word verifier (KWV) model trained to verify the wake-up command,
wherein to perform the user-specific training, the instructions further cause the device to train the KWV model using the user-specific training data to obtain a user-specific KWV model, and
wherein the user-specific wake-up model comprises the KWD model and the user-specific KWV model.

20. The non-transitory computer-readable medium of claim 18, the instructions further cause the device to:
detect, using the user-specific wake-up model, a new wake-up command included in a new voice input received from the user;
based on the detecting of the new wake-up command, perform a new speech recognition operation based on the voice input; and
based on a result of the new speech recognition operation indicating that a performance of the user-specific wake-up model is below a threshold performance, obtain new user-specific training data based on the new voice input and the result of the new speech recognition operation, and perform additional user-specific training on the user-specific wake-up model based on the new user-specific training data.
